(19) United States
(12) Patent Application Publication
(10) Pub. No.: US 2007/0101994 A1
(43) Pub. Date: May 10, 2007

(54) Aerosol inhalation apparatus

(76) Inventor: Lewis W. Waters, Bedford, MA (US)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/268,519

(22) Filed: Nov. 8, 2005

(51) Int. Cl. A62B 7/10

(52) U.S. Cl. 128/205.12; 128/200.14

(57) ABSTRACT

An aerosol inhalation apparatus for dispensing a medication, such as but not limited to cyclosporine, includes a disposable aerosol inhalation device for use in producing properly sized particles as a mist. The disposable device includes a nebulizer, a first conduit, a second conduit, a third conduit and a fourth conduit. Exhalation to an entrapping Hepa filter is effected via the third conduit which has a one-way valve therein. The first and second conduits, respectively, communicate with a baffled nebulizer and the ambient, a one-way valve being provided within the second conduit. The apparatus includes a mouthpiece having a shut-off arrangement allowing passage of the aerosol therethrough when the mouthpiece is within the patient's mouth. The shut-off arrangement is closed when the mouth piece is out of the patient's mouth to minimize possible contamination of the ambient by discharge of the aerosol mist through the mouthpiece into the ambient.

### BACKGROUND OF THE INVENTION

This invention relates to an aerosol inhalation method and apparatus which includes a disposable pulmonary inhalation device which includes means to generate properly sized aerosol particles.

The method and apparatus is especially useful for aerosolizing solutions to the proper aerosol particle size, and to collect aerosol particles in a proper filter to avoid environmental and/or ambient contamination. The device is suitable for delivering aerosols to a subject undergoing treatment or prophylaxis and to patients undergoing heart-lung transplants or chemotherapy.

Pulmonary dosing systems are efficient in delivering drugs. This can be important with respect the time spent by the patient and the support staff for each treatment and also with respect to reducing the expense of using extremely costly drugs. The efficiency refers not only to the efficiency of delivering drug to the patient but also to the efficiency of getting the delivered drug to penetrate deep into the lung of the patient to provide the needed therapy.

With respect to lung or heart-lung transplants, part of the protocol is to treat the lung with a drug such as Cyclosporin to suppress the immune system so that the patient does not reject the transplant. Chemotherapy involves the administration of toxic drugs. In both cases it is desirable to minimize, if not eliminate, escape of these drugs into the surrounding environment where they may be inhaled by attending medical personnel or others. With the treatment of diseases such as, but not limited to Pneumocystis carinii Pneumonia (PCP), it is also desirable not only to limit drug exposures to medically effective amounts but to minimize the amounts of aerosolized drug particles in the atmosphere.

### SUMMARY OF THE INVENTION

An aerosol inhalation apparatus for supplying an aerosol mist to a patient comprises a disposable aerosol inhalation device including a nebulizer having a compressed air inlet and an outlet for an aerosol mist generated therein. A first conduit is in fluid communication with said outlet of said nebulizer. A second conduit having a first one-way valve therein for providing one-way fluid communication from ambient to an intersection is disposed between the first conduit and said second conduit. A third conduit provides fluid communication from the intersection between the first conduit and the second conduit and a Hepa filter is coupled to the third conduit. A second one-way valve is positioned in the third conduit for providing one-way fluid communication from the intersection to the ambient via the filter and a fourth conduit provides fluid communication between a mouthpiece for communicating with an airway of a patient and the intersection. The mouthpiece has a shut-off associated therewith which allows passage of the aerosol through the mouthpiece when the mouthpiece is within the patient's mouth, however when the shut-off is out of the patient's mouth the shut-off is closed to minimize possible contamination of the ambient by discharge of the aerosol through the mouth piece into the ambient. The apparatus includes a source of compressed air. A coupling for coupling said source of compressed air to said compressed air inlet of the nebulizer is provided for delivering compressed air thereto, whereby the one-way fluid communication from ambient to the intersection between the first conduit and the second conduit eases the patient's breathing by allowing inhalation independent of the source of compressed air.

In a further aspect of the apparatus, the shut-off arrangement comprises a two-way valve that is normally closed when outside a patient's mouth and opens when placed in a patient's mouth.

In a further aspect, the two-way valve is integral with the mouthpiece.

In still a further aspect of the shut-off, includes a normally closed valve and an operator associated with the mouthpiece, which operator detects when the mouthpiece is positioned in the patient's mouth and is connected to the normally closed valve to open the normally closed valve when the mouth piece is inserted in the patient's mouth.

In another embodiment of the shut-off arrangement, the shut-off arrangement is associated with a vent hole positioned downstream of the compressor and upstream of the nebulizer. In this embodiment, the shut-off arrangement comprises of a two-way valve having a valve closure which is normally biased to a first position preventing air from the compressor from flowing to the nebulizer. The two-way valve is movable from the first position to a second position allowing flow from the compressor to the nebulizer upon closing the vent hole so that when the mouthpiece is positioned in the patient's mouth and the vent hole is closed, preferably but not necessarily by the patient or medical attendant's finger being placed over the vent hole, the aerosol is delivered to the patient. Upon uncovering the hole before removing the mouthpiece, aerosol flow to and through the mouthpiece ceases.

In still a further aspect of the nebulizer, the nebulizer includes a reservoir portion for holding liquid therein which includes particles of drug therein, the drug being suited for site-specific delivery of the particles to the lungs of a patient.

In a specific aspect, the nebulizer has a reservoir portion for holding an emulsion containing particles of cyclosporine therein, the cyclosporine particles being especially suited for site-specific delivery to the lungs of a patient.

### BRIEF DESCRIPTIONS OF THE DRAWINGS

Various other features and attendant advantages of the present invention will be more fully appreciated as the same becomes better understood when considered in conjunction with the accompanying drawings, in which like reference characters designate the same or similar parts throughout the several views, and wherein:

FIG. 1 is a perspective view of a first exemplary embodiment of an aerosol inhalation apparatus constructed in accordance with the present invention.

FIG. 2 is a fragmentary perspective diagrammatic view of a portion of the apparatus of FIG. 1 illustrating a nebulizer with its internal baffle which is suitable for use in the aerosol inhalation apparatus illustrated in FIG. 1.

FIG. 3 is a fragmentary perspective diagrammatic view of a conduit and filter arrangement, which may be used as a substitute for a portion of the aerosol inhalation apparatus of FIG. 1, in accordance with a second exemplary embodiment of the present invention.

FIG. 4 is a fragmentary perspective diagrammatic view of a conduit and filter arrangement, which may be used as a substitute for a portion of the aerosol inhalation apparatus of FIG. 1, in accordance with a third exemplary embodiment of the present invention.

FIG. 5 is a fragmentary perspective diagrammatic view of a conduit and filter arrangement, which may be used as a substitute for a portion of the aerosol inhalation apparatus of FIG. 1, in accordance with a fourth exemplary embodiment of the present invention.

FIG. 6A is a side view of a first embodiment of a mouthpiece valve showing the mouthpiece valve open.

FIG. 6B is a side view of the mouthpiece of FIG. 6A showing the mouthpiece valve of FIG. 6A closed.

FIG. 7A is a side view of the mouthpiece of a second embodiment of a mouthpiece valve showing the mouthpiece open.

FIG. 7B is a side view of the mouthpiece valve of FIG. 7A showing the mouthpiece valve closed.

FIG. 8A is a side view of a third embodiment of a mouthpiece valve showing the mouthpiece valve open.

FIG. 8B is a view taken along lines 8B-8B of FIG. 8A.

FIG. 8C is a side view of the mouthpiece valve of FIGS. 8A and 8B showing the mouthpiece valve open.

FIG. 8D is a section view taken along lines 8D-8D of FIG. 8C.

FIG. 8E is a view similar to FIG. 1, but showing the mouthpiece prior to insertion.

FIG. 9A is a side elevation of a fourth embodiment of a mouthpiece valve showing the mouthpiece valve open.

FIG. 9B is a side view of the mouthpiece valve of FIG. 9A showing the mouthpiece valve closed.

FIG. 10 is a side view of a sensor in the mouthpiece for allowing the compressor to provide compressed air to the nebulizer of the apparatus only when the mouthpiece is in the patient's mouth.

FIG. 11A is a side view of a trigger-type mechanism for blocking airflow from a motor compressor to the nebulizer and showing the airflow unblocked.

FIG. 11B is a view similar to FIG. 11A but showing the airflow to the nebulizer blocked.

### DETAILED DESCRIPTION

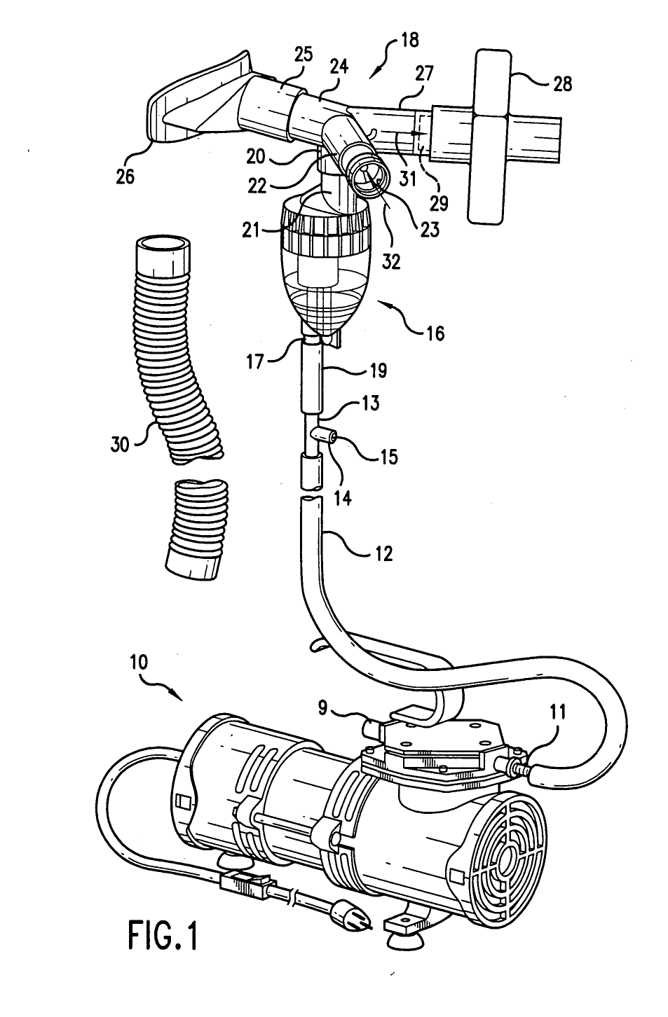

FIG. 1 illustrates a first embodiment of an aerosol inhalation apparatus suitable for administering toxic drugs during chemotherapy and suitable for administering drugs for suppressing autoimmune responses to lung and heart-lung transplants. The apparatus of FIG. 1 is also useable for treating and/or prophylaxis of pneumonia and other disorders of the lungs and other diseases, and for treating disorders involving medications which can be dispensed in aerosol form.

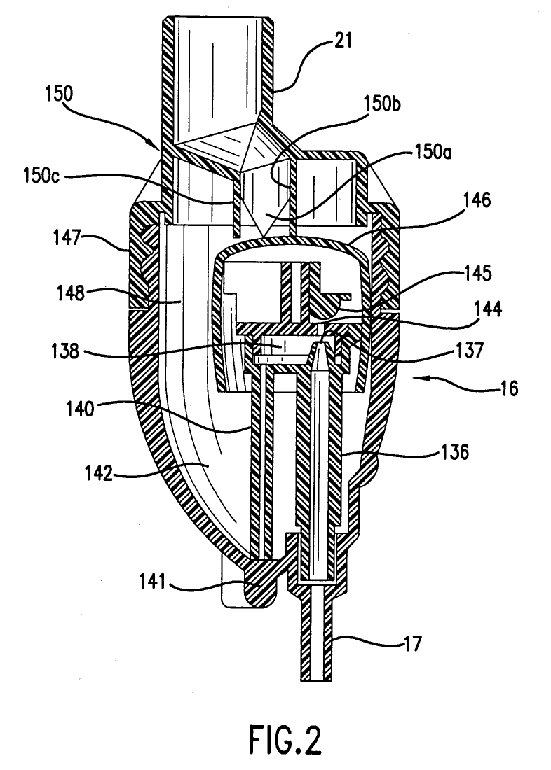

The apparatus of FIG. 1 includes an electric a.c. motor driven compressor, the motor-compressor being designated generally by the numeral 10. In a realized embodiment, a motor-compressor unit available commercially under Model designation MDA-P 109-AA from the Gast Mfg. Corp. of Benton Harbor, Mich. was used. The motor-compressor 10 is used to generate compressed air at a pressure of about 35-50 (and preferably 40) pounds per square inch and, in use provides a flow rate of about 8 to 10 liters per minute thruput to a patient. Ambient air is supplied to the motor-compressor 10 via an inlet illustrated by a tubular member 9. The compressed air from the motor-compressor 10 exits from a threaded fitting 111 and into a flexible conduit 12, the output end of which is positioned over an end of a T-shaped coupler 13 having an internal bore in fluid communication with an end of a further flexible conduit 19, the other arm 14 of T-shaped coupler 13 is provided with a bore that provides a vent opening 15 for fluid communication from the internal bore within the coupler 13 to the ambient. The purpose of the vent opening 15 is to provide a means for allowing the compressed air from the motor-compressor 10 to exhaust to the ambient unless a person treating a patient or the patient places a finger over the vent opening 15, causing the compressed air from the conduit 12 to enter the conduit 19 and be passed into a baffled nebulizer 16, via a hollow stem 17. The baffled nebulizer 16 is shown in more detail in FIG. 2 to which reference is to be made hereinbelow. The baffled nebulizer 16 contains a toxic substance, such as for example, cyclosporin, for suppressing autoimmune responses during transplant procedures, or a chemotherapy drug.

In fluid communication with the interior of the nebulizer 16 is four-way conduit assembly formed as a integral unit 18 of a plastic. The integral unit 18 includes a first conduit 20 which fits over an outlet 21 from the nebulizer 16. A second conduit 22 having a one-way flap valve 23 therein provides a one-way path for ambient air to enter the unit 18, as indicated by the arrowheaded line 32, and mix with the mist and compressed air from the nebulizer 16, an intersection being provided between the first conduit 20 and the second conduit 22. A one-way valve 23 prevents the aerosol mist and air from the motor-compressor 10 as well as exhaled materials from a patient from being passed to the ambient.

The air supplied from the ambient via the one-way valve 23 and the conduit 22 with the aerosol mist from the nebulizer 16 is inhaled by the patient via a fourth conduit 24 and through a mouthpiece 26 provided with a tubular connection portion 25 into the patient's mouth 29. The patient or a therapist merely places his or her finger over the vent opening 15 in the coupler 13 to produce the aerosol mist from a solution containing the treating agent which has been positioned within a reservoir portion of the nebulizer 16. It is to be understood that a trigger-operated valve arrangement or the like can be used in place of the fitting 13. In either case the treating agent, which is expensive, is conserved and the breathing of the patient made easier. A third conduit 27 extends from the intersection of the conduits 20, 22 and 24 to a Hepa filter 28, via a one-way valve 29 which allows the patient to exhale into the ambient as indicated by the arrowheaded line 31, the filter 28 removing the aerosolized treating agent as well as microorganisms, including viruses. In a realized embodiment of the apparatus, a commercially available filter sold under the Model No. 0811 by Amici Inc. of 740 Walnut Street, Rogersford, Pa. was used to filter out microorganisms. Thus, protecting the environment and personnel from the patient.

In a now preferred embodiment of the invention when the nebulizer 16 uses a toxic material such as cyclosporin, the filter 28 is an HEPA filter which filters out toxic materials using absorbers such as activated charcoal. The filter 28 could also employ an electrostatic precipitator. A suggested HEPA filter is an ISO Gard Hepa Light Filter, such as Code ISG-HUD 28022, available from Hudson RCI of Temenla, Calif.

In the event one wishes to place the patient at some distance from the unit 18, the mouthpiece 26 may be removed from the end of the fourth conduit 24 and a flexible tubular conduit 30 positioned between the mouthpiece 26 and the open end of the conduit 24. The unit consisting of the nebulizer 16, the filter 28, the unit 18 and the mouthpiece 26, as well as the conduit 30, can be discarded after use and is intended for single patient use.

The details of the preferred nebulizer 16 (FIG. 1) are illustrated in FIG. 2, a cross-section having been taken axially through the nebulizer 16. The nebulizer 16 includes the stem-like, tubular conduit 17 which is positioned into the upstanding portion of the flexible conduit 19 (FIG. 1). The tubular conduit 17 is fluid communication with a vertically extending tubular member 136 which has a narrowing conical end portion terminating in an opening 137, compressed air under positive pressure from the motor-compressor 10 (FIG. 1) is to pass through the tubular member 136 and out the small opening 137. The opening 137 exhausts into a chamber 138 which is in fluid communication with a downwardly extending tubular member 140 having an opening in its lower end 141 so as to be beneath the level of liquid in the nebulizer 16 which is to be placed in the bottom portion 142, which acts as a reservoir, of the interior of the nebulizer 16. The solution which is to be placed in the bottom portion of the nebulizer 16 is placed in the nebulizer by unthreading its upper portion 147 from the lower portion and placing the solution into a chamber 148 defined by the lower portion.

In close vicinity to the opening 137 and in the top portion of the chamber 138 is an aperture 144 having a relatively larger diameter portion at its uppermore end. The aperture 144 is positioned in close vicinity and immediately beneath a protrusion 145 which has a generally smooth arcuate outer surface. Positioned over the above-discussed structure and above the protrusion 145 is a baffle 146. The baffle 146 is force-fit over the structure defined by the tubular members 136 and 140, the chamber 138 and the protrusion 145. The baffle 146 has a smooth, arcuate inner surface on which droplets of liquid formed from aerosol mist particles having greater than three microns in diameter are collected, these particles running down the inner side walls of the baffle 146 so as to again collect in the bottom portion 142 of the nebulizer 16. The particle size is a function of nebulizer type, baffling and air pressure, these parameters are desirably selected to provide particles in the selected range which results in good alveolar deposition. The particles have a Gaussian distribution within the range. The range may be changed to effect a more effective deposition at diseased sites. The nebulizer 16 is constituted by the two major portions, the upper portion 147 being threadedly connected to the bottom portion, the upper portion defining internally a fluid passageway from the interior chamber 148 of the bottom portion of the nebulizer 16 and defining a passageway from the aerosol containing chamber 148. A throttle 150 is provided in the passageway between the interior chamber 148 and the tubular conduit 21, the passageway constituting a pre-determined restriction, so far as cross-section is concerned, to allow selection of the desired and/or prescribed amount of material which a patient is to inhale during a given treatment session. The throttle 150 is constituted by a plurality of downwardly extending triangularly shaped extensions 150a-150c, these extensions being bendable (when subjected to a heat treatment) so as to provide selectively a particular opening area from the chamber 148 into the rigid tubular conduit 21. As illustrated, the triangular extensions 150a-150c are shown unbent in positions providing a maximum opening area. Were one to desire a more restrictive opening, so as to subject a subject to a lesser dose of material, the end portions of the triangular extensions 150a-150c would simply be bent inwardly so as to make the opening smaller in area. As a practical matter a number of threaded upper members 147, possibly color coded, could be provided so that a user could select which throttle opening area feature was desired in a given case.

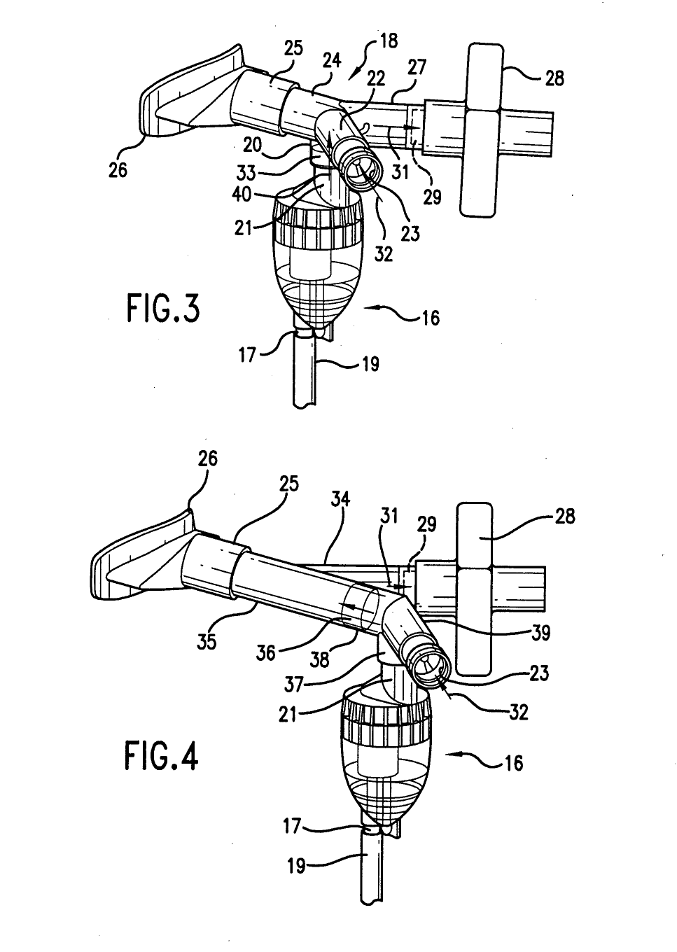

The device of FIG. 3, like the device of FIG. 1, includes a baffled nebulizer 16 provided with a hollow stem 17. The baffled nebulizer 16 may be constructed as shown in FIG. 2.

The device shown in FIG. 3 includes an integral unit 18 which is identical to the unit 18 (FIG. 1). The device differs in that a third one-way valve 33 is positioned within the conduit 20 for allowing aerosol mist to flow from the nebulizer 16 into the intersection provided between the first conduit 20 and the second conduit 22, as illustrated diagramatically by an arrowheaded line 40. The one-way valve 23 prevents material exhaled by a patient from entering the nebulizer 16. If desired the device 18 as shown in FIG. 3 may be used in conjunction with the flexible conduit 30 (FIG. 1).

FIG. 4 illustrates a third embodiment of an aerosol inhalation device. The device of FIG. 3, like the device forming a portion of the apparatus illustrated in FIG. 1, includes a baffled nebulizer 16 provided with a hollow stem 17, which may be placed into an open end of the flexible conduit 19 (FIG. 1). The baffled nebulizer 16 is shown in detail in FIG. 2.

In fluid communication with the interior of the nebulizer 16 is a three-way passage formed as a integral unit of a plastic. The integral unit includes a first conduit 37 which fits over an outlet 21 from the nebulizer 16. A second conduit 39 having a one-way flap valve 23 therein provides a one-way path for ambient air to enter the unit and mix with the mist and compressed air from the nebulizer 16, an intersection being provided between the first conduit 37 and the second conduit 39. The one-way valve 23 prevents the aerosol mist and air form the motor-compressor 10 (FIG. 1) from being passed to the ambient, as illustrated diagramatically by an arrowheaded line 32.

The air supplied from the ambient via the one-way valve 23 and conduit 39 with the aerosol mist from the nebulizer 16 is inhaled by the patient via a fourth conduit 35 and a mouthpiece 26 provided with a 26, the patient or a therapist merely placing his or her finger over the bore 15 (FIG. 1) in the coupler 13 (FIG. 1) to produce the aerosol mist from a solution containing the treating agent which has been positioned within the nebulizer 16. A third one-way valve 36 is provided within the fourth conduit 35 to allow air and aerosolized mist to flow towards the mouthpiece 26, as illustrated by the arrowheaded line 38, while preventing reverse flow. A third conduit 34 extends from an intersection with the fourth conduit 35 to a toxic material or a bacteria-viral filter 28, via a one-way valve 29 which allows the patient to exhale into the ambient, the filter 28 removing microorganisms, including viruses as well as the aerosolized treating agent. The device shown in FIG. 4 can be discarded after use and is intended for single patient use.

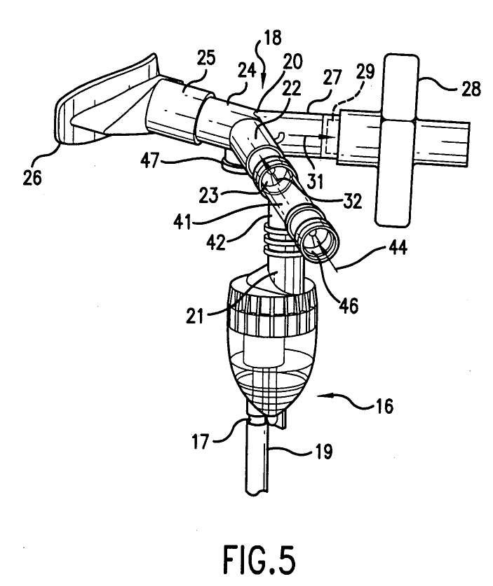

FIG. 5 illustrates a fourth embodiment of an aerosol inhalation device suitable for treating and/or prophylaxis of pneumonia, and the like. The device of FIG. 5, like the device forming a portion of the apparatus of FIG. 1, includes a baffled nebulizer 16 which includes a hollow stem 176 which is to be placed into the open end of the flexible conduit 19 (FIG. 1).

In fluid communication with the interior of the nebulizer 16, as shown in FIG. 5, is a conduit 42 which extends downwardly from an intersection with a tubular extension 41 fitted into the open end of the second conduit 22 of the unit 18 which is constructed identically to the disposable unit 18. A third one-way valve 46 is positioned within the tubular extension 41 to permit intake of air from ambient, as indicated diagramatically by the arrowheaded line 44, while preventing outflow of exhalent material, compressed air and mist. The integral unit 18 includes a first conduit 20 which may fit over the outlet 21 from the nebulizer 16, were the nebulizer 16 removed from its illustrated position, and a cap 47 removed from the open end of the conduit 20. Were this done and the extension 41 removed, the resulting structure would be identical to the device of FIG. 1. The second conduit 22, having a one-way flap valve 23 therein, provides a one-way path for ambient air, the mist and compressed air from the nebulizer 16, an intersection being provided between the first conduit 20 and the second conduit 22. The one-way valve 44 prevents the aerosol mist and air from the motor-compressor 10 from being passed to the ambient when configured as shown in FIG. 5 and the one-way valve 23 permits passage of the aerosol mist, compressed air and ambient to the patient via the second conduit 22 and the fourth conduit 24, as indicated by the arrowheaded line 32.

The air supplied from the ambient via the one-way valves 23 and 46, via the conduit 22 with the aerosol mist from the nebulizer 16 is inhaled by the patient via the fourth conduit 24 and the mouthpiece 26 provided with the tubular connection portion 25, the patient or a therapist merely placing his or her finger over the bore 15 (FIG. 1) in the coupler 13 (FIG. 1) to produce the aerosol mist from a solution containing the treating agent which has been positioned within the nebulizer 16. The fourth conduit 27 extends from the intersection of the conduits 20, 22 and 24 to a bacteria-viral filter 28, via the one-way valve 29 which allows the patient to exhale into the ambient, as indicated diagramatically by the arrowheaded line 31. The filter 28 removes microorganisms, including viruses, and the aerosolized treating agent. The unit consisting of the nebulizer 16, the filter 28, the unit 18, the extension 41 with its valve 46 and the mouthpiece 26 can be discarded after use and is intended for single patient use. The embodiment illustrated in FIG. 5 allows one to, in effect, select one of two treatment configurations from one group of parts. The configurations are essentially the configurations shown in FIGS. 3 and 4.

The apparatus and device of the present invention is suitable for delivery of medications other than the ones mentioned above. Among the medications which may be appropriate for aerosol delivery are cyclosporine, trimetrexate, dapsone, fansidar, bactrium and leucovorin, as well as various chemotherapy medications. Many different types of one-way valves could be used in practicing the invention. The valve disclosed in the copending application Ser. No. 928,826, now U.S. Pat. No. 4,703,753 assigned to assignee of applicant, has been found in realized embodiments of the invention to be both suitable and inexpensive.

In each of the four embodiments of FIGS. 1-5, the mouth piece 26 has a shut-off arrangement 200 associated therewith which is normally closed to prevent the aerosol from emission through the mouthpiece into the ambient when the mouth piece is not in the patient's mouth.

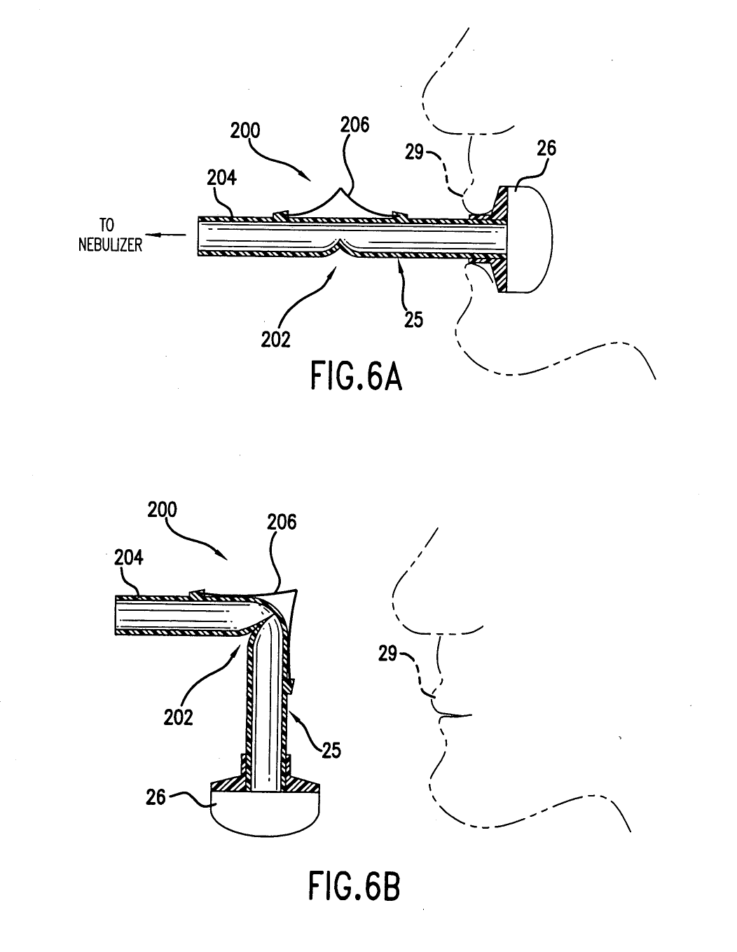

FIGS. 6A and 6B show a first embodiment 202 of the shut-off arrangement 200 wherein the tubular connecting portion 25 is configured as a flexible tube 204 having a spring 206 normally biasing the valve 202 closed. As is shown in FIG. 6A, when the mouthpiece 26 is the patient's mouth, the valve 202 is open against the bias of spring 206, and as shown in FIG. 6B when the mouthpiece 26 is out of the patient's mouth, the tube 204 is crimped causing the valve 202 to close preventing the aerosol from passing through the mouthpiece 26.

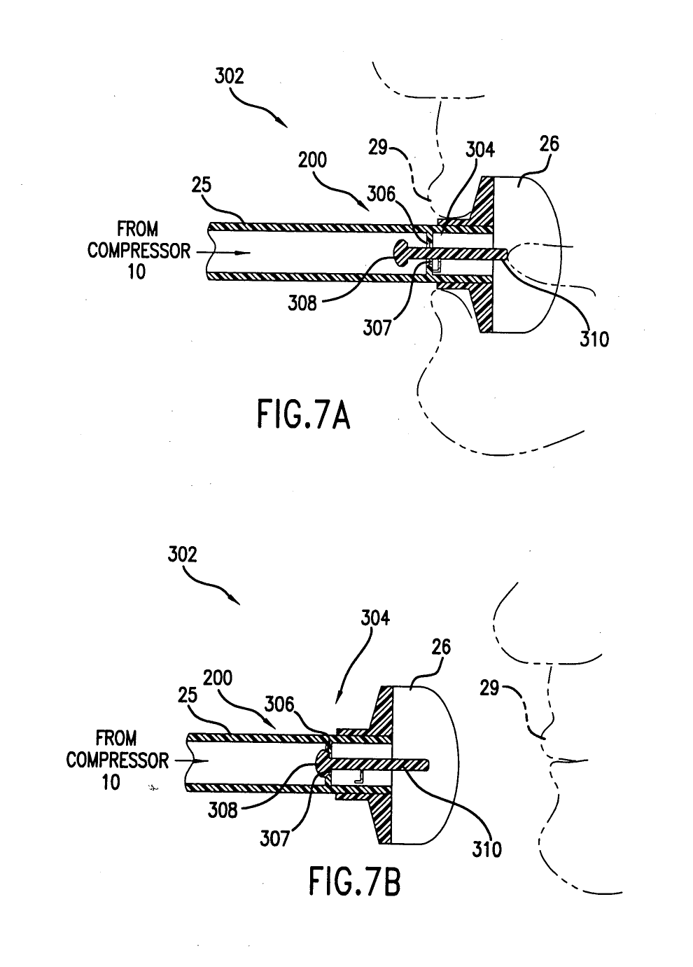

FIGS. 7A and 7B show a second embodiment 302 of the shut-off arrangement 200 wherein the tubular connecting portion 25 has a valve 304 therein which is normally closed by fluid pressure from the motor-compressor 10 applied through conduit 12 as is shown in FIG. 7B. The valve 304 comprises a valve seat 306 having an opening 307 therethrough and a valve head 308 aligned with the valve opening 307 that normally closes the opening 307 when the motor compressor 10 is supplying pressure through outlet 21 downstream of the nebulizer 16. The valve head 308 has a stem 310 extending through the valve opening 307 and into the mouthpiece 26 where the patient's tongue exerts sufficient force on the valve stem 310 to overcome the pressure upstream of the valve 302 letting the aerosol flow through the mouthpiece. Upon removing the mouthpiece 26 from the patient's mouth, pressure from the outlet 21 of the nebulizer closes the valve 304 preventing the aerosol from passing through the mouthpiece 26 into the ambient.

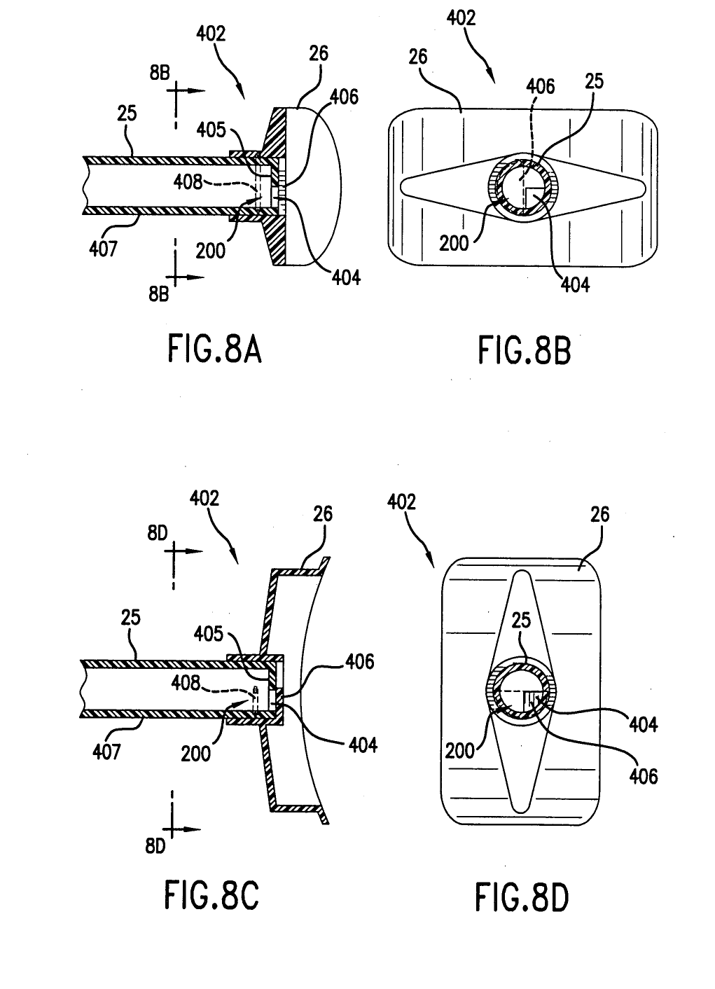

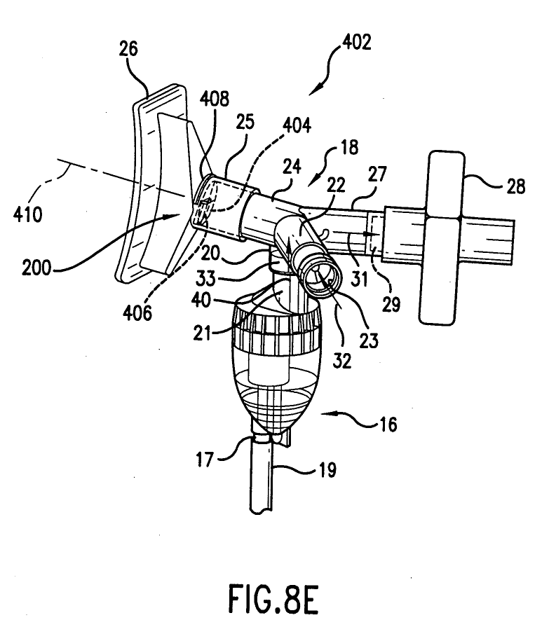

FIGS. 8A-8D show a third embodiment 402 of the shut-off arrangement 200 wherein the tubular connecting portion 25 and the mouthpiece 26 are rotatable with respect to one another preferably by about 90°. The valve 402 comprise an opening 404 at the downstream end 405 of the tubular connection portion 407 that is closed by a shutter 406 which is integral or unitary with the mouthpiece 26 and is rotatable with the mouthpiece to open and closed the valve opening 404 by uncovering and covering the valve opening 404. The shutter 406 is normally biased to cover the valve opening 404 by a spring 408 preferably in the form of an elastic band. When the mouthpiece 26 is twisted or rotated about axis 410 with respect to the tubular connecting portion 407, the valve opening 404 is uncovered so as allow the aerosol to be breathed. Generally, the tubular connecting member 26 is held in a position as is shown in FIGS. 1 and 3-5 with the nebulizer below the mouthpiece 25 and the tubular connecting member (25, 407). In order to insert the mouthpiece 25 into the patient's mouth 29, the mouthpiece must be twisted about 90° from the at rest position of FIG. 8E to the position shown in FIGS. 1 and 3-5. When the mouthpiece is withdrawn from the patient's mouth 29 the spring 408 returns the mouthpiece 25 from the position of FIGS. 1 and 3-5 to the position of FIG. 8E.

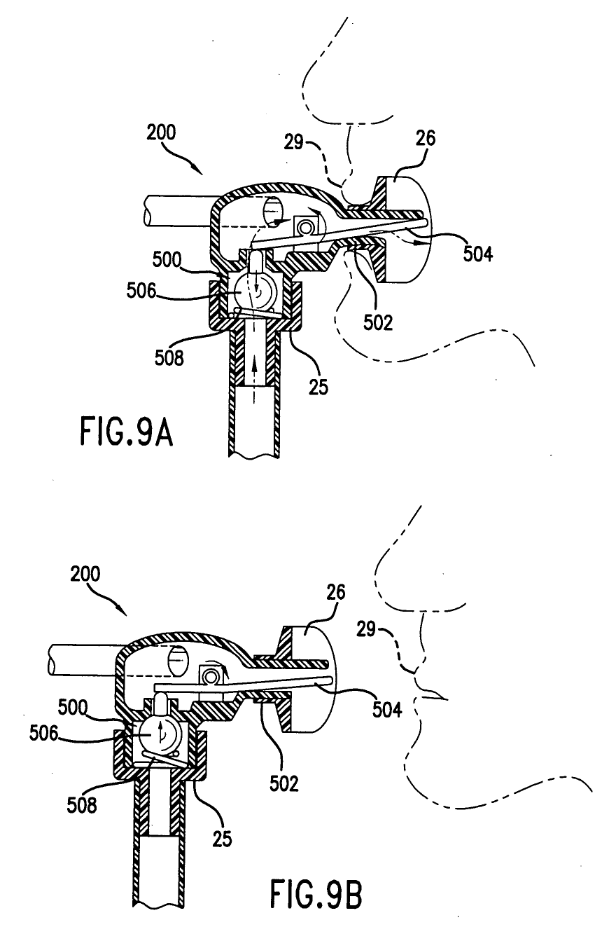

FIGS. 9A and 9B illustrate a fourth embodiment of the valve 200 wherein the valve is a bite valve 500 that is opened upon a patient inserting the mouthpiece 26 into their mouth 29 to breath therethrough, as is seen in FIG. 9A. In this embodiment, the patient bites down on a flexible insertion portion 502 that pivots a lever 504 to urge a normally closed valve member 506 to open against the bias of a spring 508. As is seen in FIG. 9B, when the lever 504 is not pivoted by the patient's bite, the normally closed valve member 206 remains closed stopping flow of aerosol through the mouthpiece 26. Consequently, when the mouthpiece 26 is taken out of the patient's mouth 29 flow through the mouthpiece into the ambient does not occur.

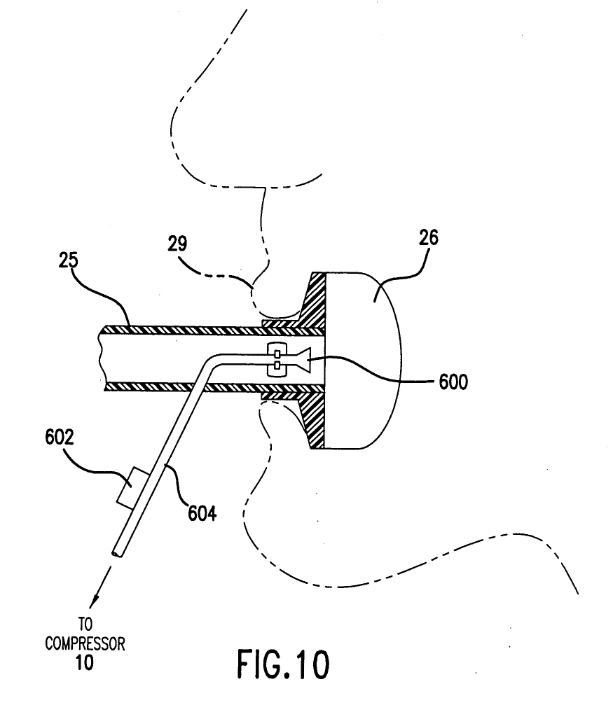

FIG. 10 shows an alternative embodiment wherein a sensor 600 extends into the mouthpiece 26 and senses that the mouthpiece is in the patient's mouth 29. The sensor is preferably electronic and may respond to any number of stimuli. An example of stimuli is pressure of the patient's mouth 29 (teeth, lips or tongue) against the sensor 600, which pressure is converted to an electrical signal which closes contacts in a relay 602 that supplies current to the motor compressor 10. When the contacts of the relay 602 are not closed, the motor compressor 10 does not supply air to the nebulizer 16. So unless the mouthpiece 26 is within the patient's mouth 29, the relay is open and the compressor is not operating. The sensor is preferably connected to the relay 602 by line 604. While the line 604 is preferably an electrical line, the line for example may be pneumatic.

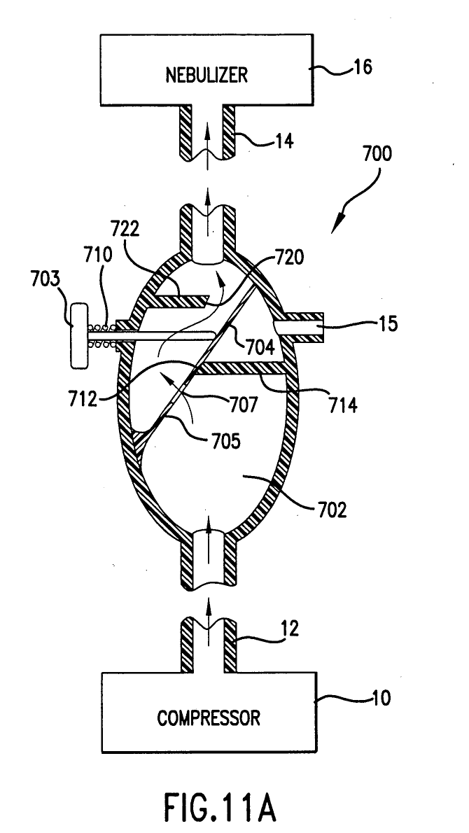

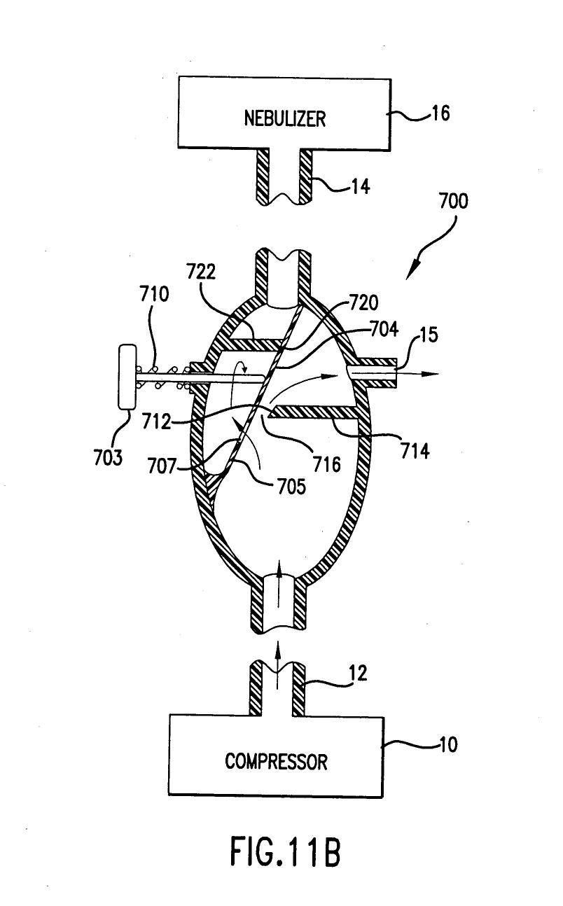

Referring now to FIGS. 11A and 11B, there is shown a trigger-type cut-off 700 disposed between the compressor 10 and the nebulizer 16. The trigger-type cut-off 700 is positioned adjacent to the vent hole 15 in chamber 702 provided between the compressed air lines 12 and 14. In FIG. 11A, when the vent hole 15 is closed by pushing a button 703 with one's fore finger, a right hand surface 704 of a flap 705 blocks compressed air from the compressor 10 from flowing out the vent 15 and allows the compressed air to flow through an opening 707 in the flap 705 to the nebulizer 16. Upon releasing the button 703, a spring 710 biases the button 703 out from the chamber 702 pulling the flap to the position of FIG. 11B. As is shown in FIG. 11B, the flap 705 disengages from the edge 712 of a projection 714, opening a gap 716 through which the compressed air passes to vent through the vent hole 15. The left hand surface 718 of the flap 705 then seals against the edge 720 of a projection 722 to prevent the compressed air from flowing to the nebulizer 16. In the arrangement of FIGS. 11A and 11B, the vent hole 15 is normally open and is closed only when the compressed air is redirected through the nebulizer 16 by pressing the button 703, as is seen in FIG. 11A.

If a mask is used covering both the nose and mouth of the patient then the valve 202 may be opened by pressure used to keep the mask sealed and in place, for example by a head strap which opens the valve 202 when slightly tensioned.

In another embodiment, a valve is disposed in the first conduit 20 or the fourth conduit 25 to interrupt flow through the open end of the mouthpiece 25. In this embodiment a small pneumatic or electrical sensor, detects the presence of the patient's mouth and sends a signal to the valve to open.

From the foregoing it will be seen that applicants' pulmonary inhalation apparatus and device provides for a disposable aerosol inhalation device which generates properly sized particles having provisions for proper valving, and ease of operation. Further, the apparatus and device has been described with reference to particular embodiments which have been set out, not by way of limitation, but by way of illustration. The embodiments of the apparatus and the device can be used in conjunction with ventilators and respirators, appropriate controlled valves being added. It is to be appreciated that many other embodiments and variants are possible within the spirit and scope of the invention, its scope being defined by the appended claims.

We claim:

1. An aerosol inhalation apparatus for supplying an aerosol mist to a patient comprising:
a disposable aerosol inhalation device, the device including a nebulizer having a compressed air inlet and an outlet for an aerosol mist generated therein, a first conduit in fluid communication with said outlet of said nebulizer, a second conduit having a first one-way valve therein for providing one-way fluid communication from ambient to an intersection between said first conduit and said second conduit, a third conduit providing fluid communication from the intersection between said first conduit and said second conduit, a Hepa filter coupled to said third conduit, a second one-way valve positioned in said third conduit for providing one-way fluid communication from the intersection to ambient via said filter and fourth conduit providing fluid communication between a mouthpiece for communicating with an airway of a patient and the intersection;
the mouthpiece having a shut-off arrangement associated therewith which shut-off arrangement is open allowing passage of the aerosol through the mouthpiece when the mouthpiece is within the patient's mouth and, which shut-off arrangement is closed when out of the patient's mouth to minimize possible contamination of the ambient by discharge of the aerosol mist through the mouth piece into the ambient;
a source of compressed air; and
a coupling for coupling said source of compressed air to said compressed air inlet of said nebulizer for delivering compressed air thereto, whereby said one-way fluid communication from ambient to the intersection between said first conduit and said second conduit eases said patient's breathing by allowing inhalation independent of said source of compressed air.

2. The apparatus of claim 2 wherein the shut-off arrangement comprises a two-way valve that is normally closed when outside a patient's mouth and opens when placed in a patient's mouth.

3. The apparatus of claim 3 wherein the two-way valve is integral with the mouthpiece.

4. The apparatus of claim 1 wherein the shut-off arrangement includes a normally closed valve and an operator associated with the mouthpiece, which operator detects when the mouthpiece is positioned in the patient's mouth and is connected to the normally closed valve to open the normally closed valve.

5. The apparatus of claim 1 wherein the shut-off arrangement is associated with a vent positioned upstream of the compressor and downstream of the nebulizer wherein the shut-off arrangement comprises a two-way valve having a valve closure which is normally biased to a first position preventing fluid flow from the compressor to the nebulizer and is movable from the first position to a second position allowing flow from the compressor to the nebulizer upon closing the vent hole.

6. The apparatus according to claim 5, wherein the vent opening is of such a diameter that it may be covered by a person's finger.

7. The apparatus according to claim 1, wherein said nebulizer comprises a hooded baffle which provides mist particles in a range of substantially one micron in diameter to substantially three microns in diameter, said range being especially suited for site-specific delivery of said particles to the lungs of said patient for treatment of pneumonia.

8. The apparatus according to claim 1, wherein the nebulizer has a reservoir portion for holding a solution and includes a solution of cyclosporin therein, said cyclosporin being especially suited for site-specific delivery of particles of cyclosporin to the lungs of said patient.

9. A disposable aerosol inhalation device comprising a nebulizer having a compressed air inlet for receiving compressed air from a source of compressed air, a reservoir portion for holding a solution and a solution of cyclosporine therein, a hooded baffle which provides mist particles in a range of substantially one micron in diameter to substantially three microns in diameter, said range being especially suited for site specific delivery of particles of cyclosporine to suppress the autoimmune response of the patient to the lungs of said patient and an outlet for an aerosol mist generated therein, a first conduit in fluid communication with said outlet of said nebulizer, a second conduit having a first one-way valve therein for providing one-way fluid communication from ambient an intersection between said first conduit and said second conduit, a third conduit providing fluid communication from the intersection between said first conduit and said second conduit, a Hepa filter coupled to said third conduit, a second one-way valve positioned in said third conduit for providing one-way fluid communication from the intersection to ambient via said filter and a fourth conduit providing fluid communication between a mouthpiece for communication with an airway of a patient and the intersection;
the mouthpiece having a two-way valve associated therewith, which two-way valve is open allowing passage of the aerosol through the mouthpiece when the mouthpiece is within the patient's mouth and which two-way valve is closed when out of the patient's mouth to minimize contamination of the ambient by discharge of the aerosol mist through the mouth piece into the ambient, and
a coupling for coupling said source of compressed air to said compressed air inlet of said nebulizer for delivering compressed air thereto, whereby said one-way fluid communication from ambient to the intersection between said first conduit and said second conduit eases said patient's breathing by allowing inhalation independent of said source of compressed air.
